(19) United States
(12) Patent Application Publication
(10) Pub. No.: US 2022/0376287 A1
(43) Pub. Date: Nov. 24, 2022

(54) ASSEMBLY CONSISTING OF A SOLID-OXIDE STACK OF THE SOEC/SOFC TYPE AND OF A COUPLING SYSTEM GASTIGHT AT HIGH TEMPERATURE WITH COUPLING FLANGE

(71) Applicant: Commissariat A L'energie atomique et aux energies alternatives, Paris (FR)

(72) Inventors: Stéphane Di Iorio, Grenoble (FR); Bastien Gervasoni, Grenoble (FR); Thibault Monnet, Grenoble (FR)

(21) Appl. No.: 17/663,588

(22) Filed: May 16, 2022

(30) Foreign Application Priority Data
May 20, 2021 (FR) 2105242

(51) Int. Cl. H01M 8/248

(52) U.S. Cl. CPC H01M 8/248; H01M 2008/1293

(57) ABSTRACT

An assembly includes a solid-oxide stack of the SOEC/SOFC type and a system for clamping the solid-oxide stack. This assembly also comprises one system for the coupling, gastight at high temperature, including a coupling flange to enable a gas inlet and/or outlet tube to pass, at least one clamping screw, provided with a clamping head, and a seal, positioned between said at least one of the top and bottom clamping plates and against the coupling flange.

### CROSS-REFERENCE TO RELATED APPLICATIONS

This application claims priority from French Patent Application No. 2105242 filed on May 20, 2021. The content of this application is incorporated herein by reference in its entirety.

### TECHNICAL FIELD

The present invention relates to the general field of the electrolysis of water at high temperature (EHT), in particular the electrolysis of steam at high temperature (EVHT), respectively designated by the English terms “high temperature electrolysis” (HTE) and “high temperature steam electrolysis” (HTSE), the electrolysis of carbon dioxide (CO₂), or even the co-electrolysis of water at high temperature (HTE) with carbon dioxide (CO₂).

More precisely, the invention relates to the field of high-temperature solid oxide electrolysers, normally designated by the acronym SOEC (standing for “solid oxide electrolyser cell” in English).

It also concerns the field of high-temperature solid-oxide fuel cells, normally designated by the acronym SOFC (standing for “solid oxide fuel cells” in English).

Thus, more generally, the invention refers to the field of solid-oxide stacks of the SOEC/SOFC type operating at high temperature.

More precisely, the invention relates to an assembly comprising a solid-oxide stack of the SOEC/SOFC type and a system for the coupling, gastight at high temperature, of the stack comprising a coupling flange, as well as a system comprising such an assembly and a furnace coupled to said stack by means of such a coupling system and an associated coupling method.

### PRIOR ART

In the context of a high-temperature solid-oxide electrolyser of the SOEC type, it is a case of transforming, by means of an electric current, within one and the same electrochemical device, steam (H₂O) into dihydrogen (H₂) and dioxygen (O₂), and/or transforming carbon dioxide (CO₂) into carbon monoxide (CO) and dioxygen (O₂). In the context of a high-temperature solid-oxide fuel cell of the SOFC type, the operation is the reverse for producing an electric current and heat while being supplied with dihydrogen (H₂) and dioxygen (O₂), typically with air and natural gas, namely with methane (CH₄). For reasons of simplicity, the following description favours the operation of a high-temperature solid-oxide electrolyser of the SOEC type implementing the electrolysis of water. However, this operation is applicable to the electrolysis of carbon dioxide (CO₂), or even the co-electrolysis of water at high temperature (HTE) with carbon dioxide (CO₂). In addition, this operation can be transposed to the case of a high-temperature solid-oxide fuel cell of the SOFC type.

To achieve the electrolysis of water, it is advantageous to implement it at high temperature, typically between 600 and 1000° C., since it is more advantageous to electrolyse steam than liquid water and because part of the energy necessary for the reaction can be provided by heat, which is less expensive than electricity.

To implement electrolysis of water at high temperature (HTE), a high-temperature solid-oxide electrolyser of the SOEC type consists of a stack of elementary patterns each including a solid-oxide electrolysis cell, or electrochemical cell, consisting of three anode/electrolyte/cathode layers superimposed on one another, and interconnection plates often made from metal alloys, also referred to as dual-pole plates or interconnectors. Each electrochemical cell is gripped between two interconnection plates. A high-temperature solid-oxide electrolyser of the SOEC type is then an alternating stack of electrochemical cells and interconnectors. A high-temperature solid-oxide fuel cell of the SOFC type consists of the same type of stack of elementary patterns. Since this high-temperature technology is reversible, the same stack can operate in electrolysis mode and produce hydrogen and oxygen from water and electricity, or in fuel cell mode and produce electricity from hydrogen and oxygen.

Each electrochemical cell corresponds to an electrolyte/electrode assembly, which is typically a multilayer ceramic assembly the electrolyte of which is formed by a conductive central layer of ions, this layer being solid, dense and gastight, and gripped between the two porous layers forming the electrodes. It should be noted that additional layers may exist, but which merely serve to improve one or more of the layers already described.

The interconnection devices, which are electrical and fluidic, are electron conductors that, from an electrical point of view, provide the connection of each elementary-pattern electrochemical cell in the stack of elementary patterns, guaranteeing electrical contact between a face and the cathode of a cell and between the other face and the anode of the following cell, and from a fluidic point of view, thus combining the production of each of the cells. The interconnectors thus fulfil the functions of bringing and collecting electric current and delimiting compartments for the gases to circulate, and for distribution and/or collection.

More precisely, the main function of the interconnectors is to provide the passage of the electric current but also the circulation of the gases in the vicinity of each cell (namely: steam injected, hydrogen and oxygen extracted for the HTE electrolysis; air and fuel including injected hydrogen and extracted water for an SOFC cell), and to separate the anode and cathode compartments of two adjacent cells, which are the compartments for circulation of the gases and respectively the anodes and cathodes of the cells.

In particular, for a high-temperature solid-oxide electrolyser of the SOEC type, the cathode compartment includes steam and hydrogen, produced from the electrochemical reaction, while the anode compartment includes a draining gas, if present, and oxygen, another product of the electrochemical reaction. For a high-temperature solid-oxide fuel cell of the SOFC type, the anode compartment includes the fuel, while the cathode compartment includes the oxidant.

To implement the electrolysis of steam at high temperature (HTE), steam (H₂O) is injected into the cathode compartment. Under the effect of the electric current applied to the cell, the dissociation of the water molecules in the form of steam is achieved at the interface between the hydrogen electrode (cathode) and the electrolyte: this dissociation produces dihydrogen gas (H₂) and oxygen ions (O²⁻). The dihydrogen (H₂) is collected and discharged at the hydrogen compartment outlet. The oxygen ions (O²⁻) migrate through the electrolyte and recombine as dioxygen (O₂) at the interface between the electrolyte and the oxygen electrode (anode). A draining gas, such as air, can circulate at the anode and thus collect the oxygen generated in gaseous form at the anode.

To ensure the operation of a solid-oxide fuel cell (SOFC), air (oxygen) is injected into the cathode compartment of the cell and hydrogen into the anode compartment. The oxygen of the air will dissociate into O²⁻ ions. These ions will migrate in the electrolyte of the cathode towards the anode to oxidise the hydrogen and form water with a simultaneous production of electricity. In an SOFC cell, just like in an SOEC electrolyser, the steam is located in the dihydrogen (H₂) compartment. Only the polarity is reversed.

By way of illustration, FIG. 1 represents a schematic view showing the operating principle of a high-temperature solid-oxide electrolyser of the SOEC type. The function of such an electrolyser is to transform the steam into hydrogen and oxygen in accordance with the following electrochemical reaction:

2H₂O→2H₂+O₂.

This reaction is implemented electrochemically in the cells of the electrolyser. As shown schematically on FIG. 1, each elementary electrolysis cell 1 is formed by a cathode 2 and an anode 4, placed on either side of a solid electrolyte 3. The two electrodes (cathode and anode) 2 and 4 are electron and/or ion conductors, made from porous material, and the electrolyte 3 is gastight, electron-insulating and ion-conductive. The electrolyte 3 may in particular be an anion conductor, more precisely an anion conductor of O²⁻ ions, and the electrolyser is then referred to as an anion electrolyser, in contradistinction to proton (H⁺) electrolytes.

The electrochemical reactions take place at the interface between each of the electron conductors and the ion conductor.

At the cathode 2, the half reaction is as follows:

2H₂O+4e⁻→2H₂±2O²⁻.

At the anode 4, the half reaction is as follows:

2O²⁻→O₂+4e⁻.

The electrolyte 3, interposed between the two electrodes 2 and 4, is the site of migration of the O²⁻ ions under the effect of the electrical field created by the difference in potential imposed between the anode 4 and the cathode 2.

As illustrated between parentheses on FIG. 1, the steam at the cathode inlet can be accompanied by hydrogen H₂ and the hydrogen produced and recovered at the outlet can be accompanied by steam. Likewise, as illustrated in broken lines, a draining gas, such as air, can furthermore be injected at the inlet to discharge the oxygen produced. An additional function of the injection of a draining gas is to fulfil the role of heat regulator.

An elementary electrolyser, or electrolysis reactor, consists of an elementary cell as described above, with a cathode 2, an electrolyte 3 and an anode 4, and two interconnectors that fulfil the functions of electrical, hydraulic and thermal distribution.

To increase the rates of hydrogen and oxygen produced, stacking a plurality of elementary electrolysis cells on one another while separating them by interconnectors is known. The assembly is positioned between two end interconnection plates that support the electrical supplies and gas supplies to the electrolyser (electrolysis reactor).

A high-temperature solid-oxide electrolyser of the SOEC type thus comprises at least one, generally a plurality of electrolysis cells stacked on one another, each elementary cell being formed by an electrolyte, a cathode and an anode, the electrolyte being interposed between the anode and the cathode.

As indicated previously, the fluidic and electrical interconnection devices that are in electrical contact with one or more electrodes in general fulfil the functions of bringing and collecting electric current and delimiting one or more gas-circulation compartments.

Thus, the function of the so-called cathode compartment is the distribution of the electric current and steam and the recovery of the hydrogen at the cathode in contact.

The function of the so-called anode compartment is the distribution of the electric current and the recovery of the oxygen produced at the anode in contact, optionally by means of a draining gas.

FIG. 2 shows an exploded view of elementary patterns of a high-temperature solid-oxide electrolyser of the SOEC type according to the prior art. This electrolyser includes a plurality of elementary electrolysis cells C1, C2, of the solid-oxide (SOEC) type, stacked in alternation with interconnectors 5. Each cell C1, C2 consists of a cathode 2.1, 2.2 and an anode (only the anode 4.2 of the cell C2 is shown), between which an electrolyte is disposed (only the electrolyte 3.2 of the cell C2 is shown).

The interconnector 5 is typically a component made from metal alloy that provides the separation between the cathode 50 and anode 51 compartments, defined by the spaces included between the interconnector 5 and the adjacent cathode 2.1 and between the interconnector 5 and the adjacent anode 4.2 respectively. It also provides the distribution of the gases to the cells. The injection of steam into each elementary pattern takes place in the cathode compartment 50. The collection of the hydrogen produced and of the residual steam at the cathode 2.1, 2.2 is implemented in the cathode compartment 50 downstream of the cell C1, C2 after dissociation of the steam by it. The collection of the oxygen produced at the anode 4.2 is implemented in the anode compartment 51 downstream of the cell C1, C2 after dissociation of the steam by it. The interconnector 5 provides the passage of the current between the cells C1 and C2 by direct contact with the adjacent cells, i.e. between the anode 4.2 and the cathode 2.1.

The operating conditions of a high-temperature solid-oxide electrolyser (SOEC) being very close to those of a solid-oxide fuel cell (SOFC), the same technological constraints are found.

Thus, the correct operation of such solid-oxide stacks of the SOEC/SOFC type operating at high temperature mainly requires satisfying the points stated below.

First of all, it is necessary to have electrical insulation between two successive interconnectors otherwise the electrochemical cell would be short-circuited, but also good electrical contact and sufficient contact surface between a cell and an interconnector. The lowest possible ohmic resistance is sought between cells and interconnectors.

Moreover, it is necessary to have gastightness between the anode and cathode compartments otherwise there will be a recombination of the gases produced, giving rise to a drop in efficiency and especially the appearance of hot spots damaging the stack.

Finally, it is essential to have a good distribution of the gases both at the inlet and at the recovery of the products otherwise there would be a loss of efficiency, non-homogeneity of pressure and temperature within the various elementary patterns, or even prohibitive degradations of the electrochemical cells.

The incoming and outgoing gases in a high-temperature electrolysis stack (SOEC) or of a fuel-cell stack (SOFC) operating at high temperature can be managed by means of suitable devices of a furnace such as the one illustrated with reference to FIG. 3.

The furnace 10 thus includes cold parts PF and hot parts PC, the latter comprising the furnace hearth 11, a looped tube 12 for managing the entries and exits of gas and the high-temperature electrolysis (SOEC) or fuel-cell (SOFC) stack 20.

The couplings of the gas feed and exit devices usually take place at the cold parts PF, in particular by double-ring mechanical clamping couplings, VCR® metal-gasket surface-seal couplings, welded connections or gastight partition bushings.

In the case of double-ring mechanical clamping couplings, the two rings separate the gastightness and tube-clamping functions. The front ring creates a seal while the rear ring makes it possible to advance the front ring axially and applies effective tube clamping and very good impermeability to gas leaks. In addition, installing same is easy and has very good resistance to fatigue caused by vibrations. Dismantling is easy in the case of absence of welding. However, the major drawbacks thereof are precisely its absence of resistance to high temperatures so that the rear ring, the front ring and the tube may weld together by diffusion welding, making the junction non-demountable.

In the case of VCR® metal-gasket surface-seal couplings, the seal is obtained when the gasket is compressed by two protrusions during the clamping of a male nut or of a hexagonal body with a female nut. This principle affords very good gastightness, the possibility of using different gaskets (nickel, copper, stainless steel, etc.) according to the most suitable configuration, and easy mounting/demounting with change of gasket during these operations. However, this solution is not suitable at high temperature, since operation thereof allows a maximum temperature of only approximately 537° C.

In the case of welded connections, total gastightness is obtained by welding the tubes together by a method of the TIG type (standing for “tungsten inert gas”) or by orbital welder, i.e. a TIG method coupled to a rotary nozzle. However, the welding operations on a stack 20 mounted in a furnace 10 are very complicated because of the reduced accessibility for being able to weld the tubes over the periphery.

Finally, there is a coupling system resistant to a temperature of approximately 870° C., using gastight partition bushings for sensors, probes, electrical signals and tubes to pass. These gastight partition bushings are in the form of a 316L stainless-steel threaded coupling that is to be screwed onto the wall of a pipe, of a tank or of a cover. According to the version thereof, these bushings accept one or more through elements, of various types, sizes and diameters. These bushings therefore allow the passage of elements without discontinuity and do not allow the gastight joining of two elements.

The couplings of the gas feed and exit devices at the cold parts PF of the furnace 10 constitute a major drawback since these cold parts PF are distant from the heating elements of the furnace 10 and encumbered by the peripherals such as exchangers, insulators and condensers, among other things. This involves favouring the implementation of connections in the hot parts PC while wishing to be able to make them demountable and reusable easily.

In addition, the use of the chamber of the furnace 10 for preheating the inlet gases also leads to producing the tube in a loop 12, with a length of approximately 2.5 to 3 m, to use the radiation of the heating elements of the furnace 10, which adds to the complexity in the curves to ensure that the tubes arrive at the correct point in a confined space.

Furthermore, if it is wished to be able to dismantle the stack 20 to be able to operate it at another location, then conferring on it a character of the “Plug & Play” (PnP) type, it will be necessary first to break the connection mechanically, for example using a metal saw, and to prepare the new connections to put the stack 20 on another furnace, which greatly complicates manipulations.

Finally, it should be noted that such a stack 20 is very fragile and it is necessary to perform as few operations as possible when changing location. Thus, it is necessary in particular to be able to avoid vibrations and shocks and also to avoid turning it over.

The coupling solutions mentioned above do not make it possible to meet the requirements stated above. In particular, double-ring mechanical-clamping couplings weld at high temperature. The welds do not meet the problem mentioned because of the complexity of the welding (difficult access) and they do not avoid cutting the tubes for dismantling.

The coupling solutions of the prior art do not make it possible to withdraw the stack 20 from a furnace 10 to be able to reconnect it to another furnace 10, i.e. to have a “Plug & Play” character, without breaking the junctions mechanically, which obliges the operators responsible for the assembly/dismantling to carry out tedious work of curving, coupling and adaptation.

An example of a demountable gastight system for connecting at high temperature in SOEC/SOFC mode is known from the French patent application FR 3 061 495 A1. A mica joint is used between a smooth base and a threaded base to obtain demountable and reusable gastight connections. This system makes it possible to solve the high-temperature coupling but may however involve an excessively great leakage rate. In addition, the mica joint may leave residues following the thermal cycling that it is then necessary to eliminate before mounting another gasket.

Moreover, the French patent application FR 3 045 215 A1 describes the principle of a self-contained clamping system for a solid-oxide stack of the high-temperature SOEC/SOFC type, and the French patent application FR 3 100 932 A1 describes a principle of a coupling system gastight at high temperature using such a clamping system.

Precisely, this application FR 3 100 932 A1 describes the use of a clamping base with a first through internal conduit allowing the passage of a tube, a support base, situated in this conduit and comprising a second through internal conduit, and a seal positioned against a first end of the support base. A clamping plate includes a through gas-passage conduit with a support surface for the seal and a threaded countersink for receiving a thread of the clamping base.

This solution does however require having the tube located in the first through internal conduit that is welded to another tube located in the second through internal conduit. This weld between two tubes may create deformations that will complicate the establishment of the proposed system. In addition, it has the drawback of having to machine the clamping plate in depth. Equally, the seal is located at the bottom of a groove and is compressed by the support base, and it may be difficult to clean the support base during assembly and disassembly operations, which limits the gastightness performance. Furthermore, this solution may cause a problem of space requirement because of the large diameter of the support base that requires the use of a large key, the manipulation of which is limited by the presence of the central support stud. The presence of a single thread for clamping the seal may also lead to high clamping torques of the order of 12 N.m. Moreover, the solution may present dismantling problems since the threads may bind together because of a formulation of the anti-binding paste resistant to high temperature, based on copper, aluminium and graphite, which is not optimum. Finally, this solution does not detail the method for sealingly connecting the stack to the clamping plates.

There is therefore still a need for improving the known coupling solutions of the prior art for a high-temperature electrolysis stack (SOEC) or fuel cell (SOFC).

### DISCLOSURE OF THE INVENTION

The aim of the invention is to at least partially remedy the requirements mentioned above and the drawbacks relating to the embodiments of the prior art.

The object of the invention is thus, according to one of the aspects thereof, an assembly including:

a solid-oxide stack of the SOEC/SOFC type operating at high temperature, including:

a plurality of electrochemical cells each formed by a cathode, an anode and an electrolyte interposed between the cathode and the anode, and a plurality of intermediate interconnectors each arranged between two adjacent electrochemical cells,

a system for clamping the solid-oxide stack of the SOEC/SOFC type, including a top clamping plate and a bottom clamping plate, between which the solid-oxide stack of the SOEC/SOFC type is gripped, each clamping plate including at least two clamping orifices, the clamping system further including:

at least two clamping rods intended to each extend through a clamping orifice of the top clamping plate and through a corresponding clamping orifice in the bottom clamping plate to enable the top and bottom clamping plates to be assembled together,

clamping means at each clamping orifice of the top and bottom clamping plates intended to cooperate with said at least two clamping rods to enable the top and bottom clamping plates to be assembled together,

characterised in that it further includes:

at least one system for the coupling, gastight at high temperature, of the solid-oxide stack of the SOEC/SOFC type, attached to at least one of the top and bottom clamping plates, including:

a coupling flange attached to said at least one of the top and bottom clamping plates, the coupling flange comprising a through internal conduit to enable a gas inlet and/or outlet tube to pass, and at least one first through internal screwing orifice including a first internal thread,

at least one clamping screw, provided with a clamping head, able to be screwed into said at least one first through internal screwing orifice,

a seal, positioned between said at least one of the top and bottom clamping plates and against a first end face, opposite to a second end face, of the coupling flange,

and in that said at least one of the top and bottom clamping plates includes at least one second internal screwing orifice comprising a second internal thread opposite the first internal thread, said at least one clamping screw being able to be screwed into said at least one second internal screwing orifice for attaching the coupling flange to said at least one of the top and bottom clamping plates, and includes a through gas-passage conduit, intended to be in fluidic communication with the solid-oxide stack of the SOEC/SOFC type and said gas inlet and/or outlet tube.

The assembly according to the invention may furthermore include one or more of the following features taken in isolation or in accordance with all possible technical combinations.

Advantageously, said at least one of the top and bottom clamping plates and the coupling flange may be produced from the same material, in particular austenitic stainless steel, for example of the 310S type.

In addition, the gas inlet and/or outlet tube may include a spiral winding, comprising in particular at least four turns, for example with a diameter of 200 mm for a tube with an inside diameter of 10 mm and an outside diameter of 12 mm.

Advantageously again, said at least one clamping screw and the coupling flange may be produced from the same material, in particular austenitic stainless steel, for example of the 310S type.

Furthermore, the number of clamping screws, the number of first through internal screwing orifices and the number of second internal screwing orifices may be between 2 and 10, in particular be equal to 4.

The coupling flange may include at least one shoulder on the lateral surface of the coupling flange, in particular concave in shape.

The seal may be formed by a metal seal, in particular a flexible metal seal in a C shape, comprising a core formed by a metal helical spring with contiguous turns, a first metal envelope in which the spring is embedded, and a second metal envelope in which the first envelope is embedded.

The assembly may advantageously include a top end plate and a bottom end plate, between which the plurality of electrochemical cells and the plurality of intermediate connectors are gripped.

Said at least one of the top and bottom clamping plates may have a thickness of between 10 mm and 40 mm, in particular between 20 and 30 mm, in particular of the order of 30 mm.

This latter value is more in accordance with current practice.

Moreover, another object of the invention, according to another of its aspects, is a system, characterised in that it includes:

an assembly as previously defined,

a furnace, to which at least one gas inlet and/or outlet tube is connected, and to which the solid-oxide stack of the SOEC/SOFC type operating at high temperature is coupled for the entry and exit of gas by means of said at least one coupling system gastight at high temperature.

Furthermore, another object of the invention, according to another of its aspects, is a method for the coupling, gastight at high temperature, of a solid-oxide stack of the SOEC/SOFC type implemented by means of an assembly as defined previously or a system as defined previously, characterised in that it includes the step of coupling the solid-oxide stack of the SOEC/SOFC type to at least one gas inlet and/or outlet tube by means of said at least one coupling system gastight at high temperature.

The method may include the step of heat treatment of the coupling flange and of said at least one clamping screw before coupling.

The heat treatment step may consist of a progressive heating, in particular at a rate of 5° C./min, up to a predetermined heat-treatment temperature, in particular lying between 600 and 950° C., in particular again between 700 and 870° C., to reach a plateau at the predetermined heat-treatment temperature, in particular during a period of between 10 min and several hours, in particular between 10 min and 1 hour, and then progressive cooling, in particular at a rate of 5° C./min, to the initial temperature.

Before coupling, said at least one clamping screw may furthermore be subjected to the use of an anti-binding paste resistant to high temperature.

The anti-binding paste may have in its composition a weight proportion of chromium powder Cr₃ of between 10 and 90%, in particular of the order of 50%.

### BRIEF DESCRIPTION OF THE DRAWINGS

The invention can be better understood from the reading of the following detailed description of non-limitative examples of embodiment thereof, as well as from the examination of the schematic partial figures of the accompanying drawing, on which:

FIG. 1 is a schematic view showing the operating principle of a high-temperature solid-oxide electrolyser (SOEC),

FIG. 2 is an exploded schematic view of a part of a high-temperature solid-oxide electrolyser (SOEC) comprising interconnectors according to the prior art,

FIG. 3 illustrates the principle of the architecture of a furnace on which a high-temperature electrolysis stack (SOEC) or fuel cell (SOFC) operating at high temperature is placed,

FIG. 4 shows, in perspective and by observation from above, an example of an assembly according to the invention comprising a solid-oxide stack of the SOEC/SOFC type and a system for clamping the stack, which may include a coupling system gastight at high temperature,

FIG. 5 shows, in perspective and by observation from below, another example of an assembly according to the invention comprising a solid-oxide stack of the SOEC/SOFC type and a system for clamping the stack, furthermore comprising four coupling systems gastight at high temperature,

FIG. 6 shows, in a view in partial longitudinal section, a detail of the assembly of FIG. 5 with the bottom clamping plate and a coupling system gastight at high temperature,

FIG. 7 shows, in a partial perspective, an example of a system according to the invention including the assembly of FIG. 5 and a furnace, to which the solid-oxide stack of the SOEC/SOFC type is coupled for feeding and discharging gases by means of four coupling systems gastight at high temperature, and

FIG. 8 shows, in a view from below, a detail of the assembly of FIG. 5 with regard to a coupling system gastight at high temperature.

In all these figures, identical references may designate identical or similar elements.

In addition, the various parts shown in the figures are not necessarily shown to a uniform scale, to make the figures more legible.

### DETAILED DESCRIPTION OF PARTICULAR EMBODIMENTS

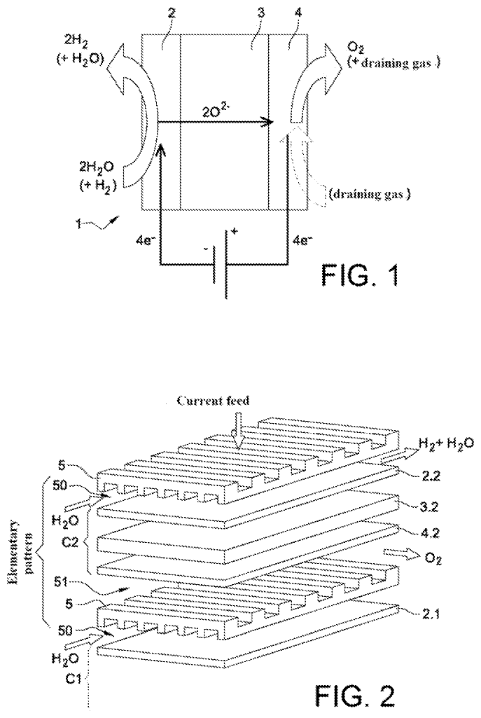

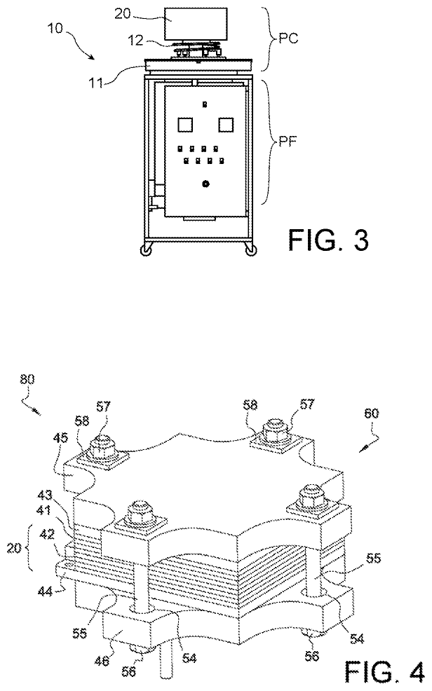

FIGS. 1 to 3 have already been described previously in the part relating to the prior art and to the technical context of the invention. It is stated that, for FIGS. 1 and 2, the symbols and the arrows for the supply of steam H₂O, for the distribution and recovery of dihydrogen H₂, of oxygen O₂, of air and of electric current, are shown for purposes of clarity and precision, to illustrate the operation of the devices shown.

Furthermore, it must be noted that all the constituents (anode/electrolyte/cathode) of a given electrochemical cell are preferentially ceramics. The operating temperature of a stack of the high-temperature SOEC/SOFC type is moreover typically between 600 and 1000° C.

In addition, any terms “top” and “bottom” are to be understood here according to the normal direction of orientation of a stack of the SOEC/SOFC type when in its configuration of use.

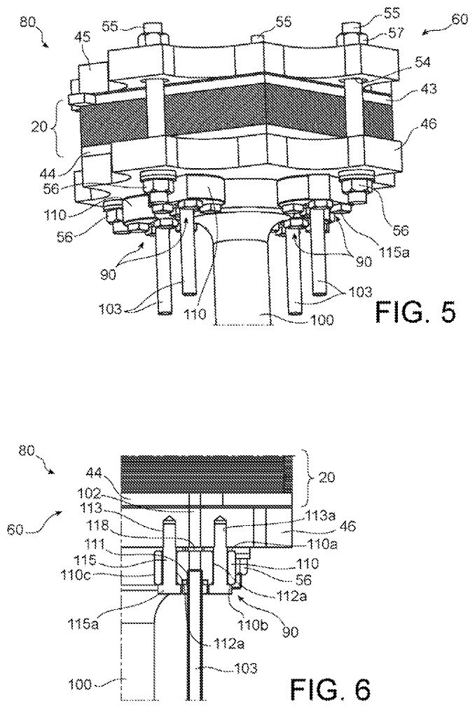

With reference to FIG. 4, an example has been illustrated of an assembly 80 comprising a solid-oxide stack 20 of the SOEC/SOFC type and a clamping system 60, this assembly 80 being able to comprise a coupling system 90 gastight at high temperature as described hereinafter with reference to FIGS. 5 to 8.

Advantageously, the assembly 80 according to the invention has a structure similar to that of the assembly described in the French patent application FR 3 045 215 A1, apart from the presence here of a coupling system gastight at high temperature 90, i.e. the stack 20 has a character of the “Plug & Play” (PnP) type.

Also, as is common to the various embodiments of the invention described hereinafter, and as can be seen in FIG. 4, the assembly 80 includes a solid-oxide stack 20 of the SOEC/SOFC type operating at high temperature.

This stack 20 includes a plurality of electrochemical cells 41 each formed by a cathode, an anode and an electrolyte interposed between the cathode and the anode, and a plurality of intermediate interconnectors 42 each arranged between two adjacent electrochemical cells 41. This assembly of electrochemical cells 41 and intermediate interconnectors 42 may also be referred to as a stack.

In addition, the stack 20 includes a top end plate 43 and a bottom end plate 44, respectively also referred to as top stack end plate 43 and bottom stack end plate 44, between which the plurality of electrochemical cells 41 and the plurality of intermediate interconnectors 42 are gripped, i.e. between which the stack is located.

Moreover, the assembly 80 also includes a system 60 for clamping the solid-oxide stack 20 of the SOEC/SOFC type, including a top clamping plate 45 and a bottom clamping plate 46, between which the solid-oxide stack 20 of the SOEC/SOFC type is gripped.

Each clamping plate 45, 46 of the clamping system 60 includes four clamping orifices 54.

In addition, the clamping system 60 furthermore includes four clamping rods 55, or tie rods, extending through a clamping orifice 54 in the top clamping plate 45 and through a corresponding clamping orifice 54 in the bottom clamping plate 46 to enable the top 45 and bottom 46 clamping plates to be assembled together.

The clamping system 60 also includes clamping means 56, 57, 58 at each clamping orifice 54 of the top 45 and bottom 46 clamping plates cooperating with the clamping rods 55 to enable the top 45 and bottom 46 clamping plates to be assembled together.

More precisely, the clamping means include, at each clamping orifice 54 of the top clamping plate 45, a first clamping nut 56 cooperating with the corresponding clamping rod 55 inserted through the clamping orifice 54. In addition, the clamping means include, at each clamping orifice 54 in the bottom clamping plate 46, a second clamping nut 57 associated with a clamping washer 58, these cooperating with the corresponding clamping rod 55 inserted through the clamping orifice 54. The clamping washer 58 is located between the second clamping nut 57 and the bottom clamping plate 46.

In accordance with the invention, the assembly 80 includes at least one system 90 for the coupling, gastight at high temperature, of the stack 20, for example as described with reference to FIGS. 5 to 8 but not visible on FIG. 4.

Such an example of a coupling system 90 gastight at high temperature will now be described with reference to FIGS. 5 to 8 relating to one and the same embodiment shown in various views. This coupling is implemented in a hot gas-inlet zone.

In this example, the assembly 80 includes four coupling systems 90 gastight at high temperature attached to the bottom clamping plate 46, in proximity to the four clamping nuts 56.

Thus, these four coupling systems 90 gastight at high temperature, for coupling to the furnace 10, are distributed regularly around a support stud 100, secured to the bottom clamping plate 46, intended to allow the support of the assembly 80 in the furnace 10.

As more particularly visible in FIG. 6, each gastight coupling system 90 includes first of all a coupling flange 110. This coupling flange 110 includes a first end face 110a opposite the bottom clamping plate 46, and a second opposite end face 110b onto which the heads 105a of the clamping screws 105 described subsequently come into abutment.

In addition, this coupling flange 110 includes a through internal conduit 111, emerging on the first 110a and second 110b end faces, which allows the passage of a tube 103 intended to provide the entry and/or exit of gas G.

Moreover, each coupling flange 110 includes four first through internal screwing orifices 112, each emerging on the first 110a and second 110b end faces and including a first internal thread 112a to allow the introduction and screwing of four clamping screws 105, each provided with a screwing head 105a. In addition, the bottom clamping plate 46 also includes four second internal screwing orifices 113 each comprising a second internal thread 113a to allow the introduction and screwing of the four clamping screws 105. In this way, the coupling system 90 is demountable.

Furthermore, each gastight coupling system 90 also includes a compressive seal 118, preferentially metallic, for example in a C shape. This seal 118 is positioned against the first end face 110a of the coupling flange 110 and against the bottom clamping plate 46. Advantageously, the seal 118 is compressed by means of easily accessible planar surfaces.

Advantageously, the seal 118 is formed by a flexible metal seal comprising: a core consisting of a metal helical spring with contiguous turns closed on itself and having, in the state of rest, the form of a torus; a first envelope made from non-ductile metal in which the spring is embedded, this envelope having, in the state of rest, the form of a toric surface the generatrix circle of which does not close on itself; and a second envelope made from ductile metal in which the first envelope is embedded and also having, in the state of rest, the form of a toric surface the generatrix circle of which does not close on itself. Such an example of a seal is described in the French patent application FR 2 151 186 A1.

The seal 118 can be produced from a nickel-based superalloy, in particular of the Inconel 600 type. It may have an inside diameter of approximately 12.5 mm and an outside diameter of approximately 17.5 mm. It may be coated with gold and the clamping torque may be between 1 N.m and 20 N.m with a preferential value 4 N.m for excessively strong adhesion.

In order to be able to mount each gastight coupling system 90 on the bottom clamping plate 46 and to provide the entry and/or exit of the gas G, the bottom clamping plate 46 includes a through conduit 102 for passage of gas G, in fluidic communication with the solid-oxide stack 20 of the SOEC/SOFC type and the tube 103 for entry and/or exit of gas G. For example, the tube 103 may be welded to the conduit 102, for example by TIG method or any other welding means. The connection of the tube 103 by welding in the internal conduit 111 is facilitated since the welding is done on a solid part that limits the deformations due to welding.

Advantageously, the bottom clamping plate 46 and the coupling flanges 110 are produced from the same material, in particular from austenitic stainless steel, in particular of the 310S type. In this way, the thermal expansions are identical.

Moreover, as can be seen in FIG. 7, which shows a system 130 according to the invention, each tube 103 includes a spiral winding 103e in order to increase the flexibility of the assembly and to be able to position the first end face 110a of the coupling flange 110 parallel to the bottom clamping plate 46. It must be noted that the number of turns and the dimensions, in particular the diameter, of the spiral winding 103e will depend on the type of tube 103 used. By way of example, the spiral winding 103e may be formed by four turns with a diameter of 200 mm for a tube 103 with an inside diameter of 10 mm and an outside diameter of 12 mm.

Advantageously, the clamping screws 115 produced from the same material as the coupling flanges 110, in particular from austenitic stainless steel, in particular of the 310S type. In this way, the thermal expansions are identical.

Although in the example described here the number of clamping screws 115 is equal to 4, this is in no way limitative. In particular, the number of clamping screws 115 may be between 2 and 10. The use of a plurality of clamping screws 115 advantageously makes it possible to limit the size thereof and to allow lesser tightening of each screw so as to limit binding. In particular, a tightening of the order of 1 to 10 N/m can be envisaged, preferentially of the order of 4 N/m.

Preferentially, before use of the coupling flanges 110 and of the clamping screws 118, heat treatment is carried out. This treatment consists in subjecting them to a temperature progressively increasing up to 800° C. at a rate of 5° C./min. Then a plateau at 800° C. is maintained for 1 hour before proceeding with a cooling by a reduction in the temperature at a rate of 5° C./min. This heat treatment can take place under air, under neutral gas or under reducing gas. The value of 800° C. is preferential but the heat-treatment temperature may be between 600 and 950° C., and preferentially between 700 and 870° C. In this way, the materials are subjected to temperatures close to those of use. The heating speed is not critical but the temperature plateau, here preferentially indicated at a duration of 1 hour, can be between 10 min and several hours.

Moreover, before fitting and clamping, the clamping screws 115, in particular the screw pitch and the parts under the heads 115a, may be subjected to the use of an anti-binding paste resistant to high temperature to facilitate dismantling and to avoid the phenomenon of diffusion welding in the threads during the thermal cycling. This anti-binding paste also lubricates the connection and resists corrosion. It avoids jamming and excessive wear on the parts exposed to extreme temperature or in a so-called aggressive atmosphere, for example in the case of threads of thermal machines, manifolds for hot gases, burners, valves, disc brakes, spark plugs, exhaust brackets, rollers, bolts, collars, etc.

This anti-binding paste is preferentially in the form of a grease comprising 50% by weight chromium powder Cr₃ and 50% by weight industrial multi-use grease based on mineral oil or any other constituent. It must be noted that the proportion of the Cr₃ powder is preferentially 50% by weight but may also be between 10 and 90% by weight. The grease obtained then has a characteristic green colour.

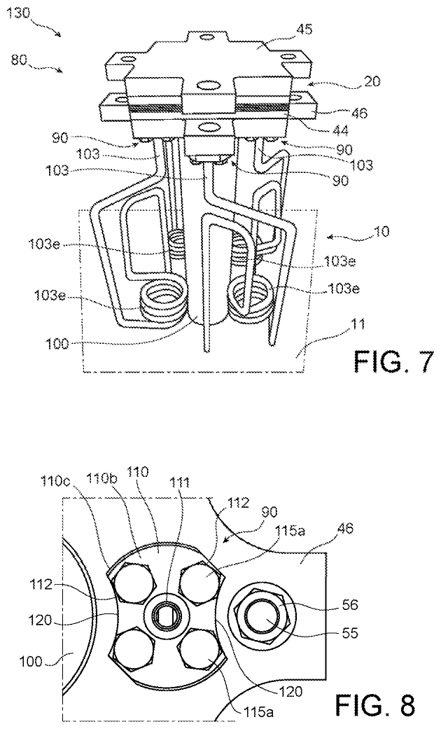

Moreover, FIG. 8 illustrates the fact that each coupling flange 110 includes at least one shoulder 120, here two opposite shoulders 120, on its lateral surface 110c. This shoulder 120 is intended to be located at the passage of the clamping screws 56 so as to obtain both a compact device and ease of implementation.

Naturally, the invention is not limited to the example embodiments that have just been described. Various modifications can be made thereto by a person skilled in the art.

1. Assembly, including:
a solid-oxide stack of the SOEC/SOFC type operating at high temperature, including:
a plurality of electrochemical cells each formed by a cathode, an anode and an electrolyte interposed between the cathode and the anode, and a plurality of intermediate interconnectors each arranged between two adjacent electrochemical cells,
a system for clamping the solid-oxide stack of the SOEC/SOFC type, including a top clamping plate and a bottom clamping plate, between which the solid-oxide stack of the SOEC/SOFC type is gripped, each clamping plate including at least two clamping orifices, the clamping system further including:
at least two clamping rods intended to each extend through a clamping orifice of the top clamping plate and through a corresponding clamping orifice in the bottom clamping plate to enable the top and bottom clamping plates to be assembled together,
clamping means at each clamping orifice of the top and bottom clamping plates intended to cooperate with said at least two clamping rods to enable the top and bottom clamping plates to be assembled together,
wherein it further includes:
at least one system for the coupling, gastight at high temperature, of the solid-oxide stack of the SOEC/SOFC type, attached to at least one of the top and bottom clamping plates, including:
a coupling flange attached to said at least one of the top and bottom clamping plates, the coupling flange comprising a through internal conduit to enable a gas inlet and/or outlet tube to pass, and at least one first through internal screwing orifice including a first internal thread,
at least one clamping screw, provided with a clamping head, able to be screwed into said at least one first through internal screwing orifice,
a seal, positioned between said at least one of the top and bottom clamping plates and against a first end face, opposite to a second end face, of the coupling flange,
and wherein said at least one of the top and bottom clamping plates includes at least one second internal screwing orifice comprising a second internal thread opposite the first internal thread, said at least one clamping screw being able to be screwed into said at least one second internal screwing orifice for attaching the coupling flange to said at least one of the top and bottom clamping plates, and includes a through gas-passage conduit, intended to be in fluidic communication with the solid-oxide stack of the SOEC/SOFC type and said gas inlet and/or outlet tube.

2. Assembly according to claim 1, wherein said at least one of the top and bottom clamping plates and the coupling flange are produced from the same material.

3. Assembly according to claim 1, wherein the gas inlet and/or outlet tube includes a spiral winding, comprising at least four turns.

4. Assembly according to claim 1, wherein said at least one clamping screw and the coupling flange are produced from the same material.

5. Assembly according to claim 1, wherein the number of clamping screws, the number of first through internal screwing orifices and the number of second internal screwing orifices is between 2 and 10.

6. Assembly according to claim 1, wherein the coupling flange includes at least one shoulder on the lateral surface of the coupling flange.

7. Assembly according to claim 1, wherein it includes a top end plate and a bottom end plate, between which the plurality of electrochemical cells and the plurality of intermediate connectors are gripped.

8. System, including:
an assembly according to claim 1,
a furnace, to which at least one gas inlet and/or outlet tube is connected, and to which the solid-oxide stack of the SOEC/SOFC type operating at high temperature is coupled for the entry and exit of gas by means of said at least one coupling system gastight at high temperature.

9. Method for the coupling, gastight at high temperature, of a solid-oxide stack of the SOEC/SOFC type implemented by means of an assembly according to claim 1, wherein it includes the step of coupling the solid-oxide stack of the SOEC/SOFC type to at least one gas inlet and/or outlet tube by means of said at least one coupling system gastight at high temperature.

10. Method according to claim 9, wherein it includes the step of heat treatment of the coupling flange and of said at least one clamping screw before coupling.

11. Method according to claim 10, wherein the heat treatment step consists of a progressive heating up to a predetermined heat-treatment temperature to reach a plateau at the predetermined heat-treatment temperature, and then progressive cooling to the initial temperature.

12. Method according to claim 10, wherein, before coupling, said at least one clamping screw is subjected to the use of an anti-binding paste resistant to high temperature.

13. Method according to claim 12, wherein the anti-binding paste has in its composition a weight proportion of chromium powder Cr₃ of between 10 and 90%.
